(19) United States
(12) Patent Application Publication
(10) Pub. No.: US 2003/0226378 A1
(43) Pub. Date: Dec. 11, 2003

(54) Slurry for and method of texturing surface of glass substrate

(75) Inventors: Hiromitsu Okuyama, Tokyo (JP); Tatsuya Tanifuji, Tokyo (JP); Yoshihiro Tawara, Tokyo (JP)

Correspondence Address: BEYER WEAVER & THOMAS LLP, P.O. BOX 778, BERKELEY, CA, 94704-0778, US

(73) Assignee: Nihon Microcoating Co., Ltd.

(21) Appl. No.: 10/365,720

(22) Filed: Feb. 11, 2003

(30) Foreign Application Priority Data
Jun. 6, 2002 (WO) PCT/JP02/05608

(51) Int. Cl. C03C 19/00; C09G 1/02

(52) U.S. Cl. 65/61; 65/111; 106/3; 451/41; 451/526

(57) ABSTRACT

Slurries to be supplied to the surface of a rotating glass substrate for texturing the surface to create streaks contain aggregates having diameters not larger than 0.51 μm of polycrystalline diamond particles that are dispersed in water or a water-based aqueous solution that is free of any substance having an etching effect on a glass material. A glass substrate is textured by supplying such a slurry material on its surface as the substrate is rotated and a polishing tape is pressed and run against the substrate surface.

### BACKGROUND OF THE INVENTION

This invention relates to slurries used for and a method of texturing the surface of a glass substrate.

A substrate for a magnetic disk has its surface or surfaces mirror-polished and is then subjected to a texturing process so as to provide a specified degree of surface roughness. The texturing process is for the purpose of forming streaks on a substrate surface such that the distance of separation between a magnetic head and the surface of the rapidly rotating magnetic disk can be stably maintained constant and also such that the adsorption of the magnetic head to the surface of the magnetic disk at rest can be prevented.

Such a texturing process is usually carried out by supplying onto the surface of the substrate a slurry material mixed with fine particles of a material such as diamond and alumina as abrading particles and pressing a polishing tape such as a woven cloth tape, a non-woven cloth tape, a tape of a foamed material or a hair-implanted tape against the substrate surface while it is caused to run. The substrate surface is mechanically polished by these fine particles pressed against it and concentrically circular streaks are thereby formed on the substrate surface. Such processing methods are typically referred to as a mechanical texturing method.

In addition to aluminum substrates made of aluminum alloys, glass substrates made of a glass material are recently coming to be used for magnetic disks. On such glass substrates, too, it is considered desirable to carry out a texturing process and to thereby create very fine and uniform streaks such that the separation between the magnetic head and the disk surface can be kept at a reduced distance and hence that the memory density of the magnetic disk as a magnetic memory medium can be increased.

There is a problem in texturing the surface of a glass substrate by a mechanical texturing method, however, because the glass substrate is fragile and finely spaced streaks could not be created on a glass surface. Abrading particles for polishing slurry are usually pre-classified but such classified abrading particles usually contain particles with diameters larger or smaller by 10-30% than the designated diameter. During a mechanical texturing process, larger-than-designated particles tend to damage the fragile glass surface or to locally create streaks that are too deep. In other words, mechanical texturing processes appropriate for aluminum substrates cannot necessarily be used on glass substrates.

For this reason, glass substrates are textured by a chemical mechanical polishing (CMP) method using an alkaline slurry material such as those having ammonium salts added thereto, as disclosed, for example, in Japanese Patent Publication Koho 3117438. The CMP method of texturing is characterized as using a slurry material containing a compound that reacts with the substrate surface chemically such as ammonium salts in a process similar to the aforementioned mechanical texturing process. With such a CMP process, it has become possible to create streaks on glass substrate surfaces. At the present time, since glass substrates are fragile and streaks cannot be easily created on them by a mechanical texturing process, it is mostly by a CMP process that glass substrates are textured.

There are problems, however, with the slurries that are used in such a CMP process. Firstly, hydroxyl groups in the slurry tend to react with water or carbon dioxide in air. Thus, it is difficult to maintain the concentration of hydrogen ions in the slurry and to maintain the product quality of the slurry. Secondly, it is both costly and troublesome to treat the waste liquid with a high concentration of hydrogen ions.

### SUMMARY OF THE INVENTION

It is therefore an object of this invention to provide a slurry used for and a method of texturing the surface of a glass substrate capable of creating fine and uniform streaks on the surface of a glass substrate without the disposal problem of a waste liquid.

Slurries embodying this invention with which the above and other objects can be accomplished may be characterized as comprising aggregates having diameters not larger than 0.5 μm of polycrystalline diamond particles and a liquid such as water or a water-based aqueous solution for dispersing these aggregates. In other words, slurries of this invention may also be characterized as not containing in the aqueous solution any substance which reacts chemically with the surface of a glass substrate and containing abrading particles not in the form of primary particles but in the form of aggregated particles.

A method according to this invention of texturing the surface of a glass substrate is similar to conventional mechanical texturing methods, comprising the steps of rotating the substrate, supplying a slurry material on the surface (or surfaces) of the substrate, and pressing a polishing tape against the surface while causing the polishing tape to run with respect to the surface but a slurry material embodying this invention must be used instead of a prior art slurry material. The polishing tape may be a woven cloth tape, a non-woven cloth tape, a foamed tape or a hair-implanted tape.

According to this invention, very fine and uniform streaks can be created on the surface of a glass substrate. Since the slurries according to this invention are nearly neutral, the waste liquid needs only to be filtered to be ready for an ordinary sewage treatment. Thus, it is not costly or troublesome to maintain a high level of quality.

### BRIEF DESCRIPTION OF THE DRAWINGS

FIG. 1 is an electron microscope photograph of aggregates of polycrystalline diamond particles in a slurry material according to this invention.

FIG. 2 is a schematic drawing of a texturing machine.

FIG. 3 is a photograph of a computer-drawn graph showing the surface condition of a glass substrate of Test Example.

FIG. 4 is a photograph of a computer-drawn graph showing the surface condition of a glass substrate of Comparison Example 1.

FIG. 5 is a photograph of a computer-drawn graph showing the surface condition of a glass substrate of Comparison Example 2.

### DETAILED DESCRIPTION OF THE INVENTION

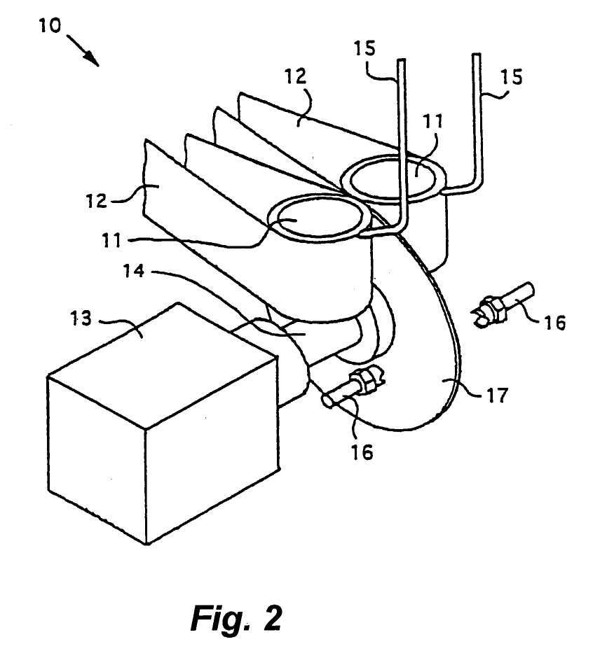

Slurries according to this invention comprise aggregates with diameters no greater than 0.5 μm of polycrystalline diamond particles and a water-based aqueous solution for dispersing these aggregated polycrystalline diamond particles. A texturing process on the surface of a glass substrate may be carried out by using a texturing machine 10 of the type shown in FIG. 2.

The texturing machine 10 shown in FIG. 2 is of a type for simultaneously texturing both surfaces of a glass substrate 17 for a magnetic disk but the present invention can be used in connection with a texturing machine (not shown) for texturing only one surface of a glass substrate at a time. A texturing process is carried out by setting the glass substrate 17 on a shaft 14 connected to a driver motor 13, causing the glass substrate 17 to rotate by driving the driver motor 13, supplying a texturing liquid onto the surfaces of the glass substrate 17 through nozzles 15 and pressing polishing tapes 12 onto the surfaces of the glass substrate 17 while causing them to run. After the texturing process, a washing liquid such as water is blown onto the surfaces of the substrate 17 through nozzles 16 to clean the substrate 17.

Examples of the polishing tapes 12 used in the above process include woven and unwoven cloth tapes of thickness 5 μm-3000 μm made of plastic fibers of thickness 0.001-5 deniers such as polyester, nylon and rayon, tapes of a foamed body (or “foamed tapes”) having a foamed layer of thickness 0.1 mm-1 mm and hardness 10-90 obtained by foaming and molding a material such as polyurethane fixed on the surface of a plastic tape of a material such as polyester or polyethylene terephthalate (as disclosed, for example, in Japanese Patent Publication Tokkai 11-151651), and hair-implanted tapes having plastic fibers of materials such as nylon of length 0.05 mm-0.5 mm implanted onto the surface of a plastic tape of a material such as polyester or polyethylene terephthalate.

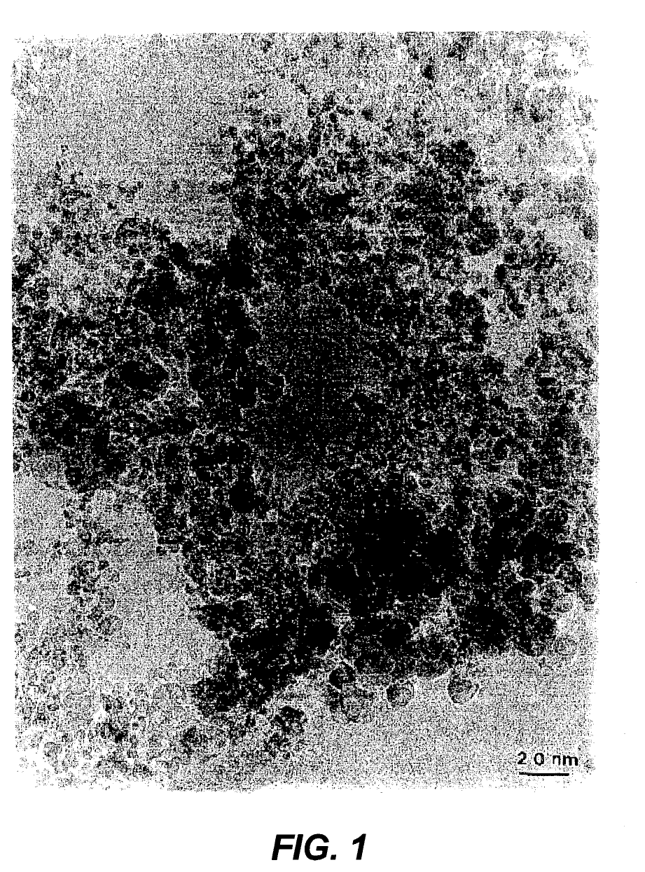

In the present invention, aggregated polycrystalline diamond particles (aggregated particles or secondary particles), that is, aggregates (secondary particles) of polycrystalline diamond particles (primary particles), having diameters no greater than 0.5 μm, are used as abrading particles. These primary particles which aggregate together to form the secondary particles are very small particles with diameters no greater than about 20 nm. There are hardly any variations in the size or shape and they are very hard and spherical without having corners, as shown in FIG. 1.

If a texturing process is carried out by using only such very small and round polycrystalline diamond particles (primary particles), these particles will easily pass through the gaps between the fibers of a non-woven cloth tape, a woven cloth tape or a hair-implanted tape or enter into gaps due to air bubbles on the surface of a foamed body, depending on the kind of polishing tape being used. In other words, it is difficult to maintain primary polycrystalline diamond particles securely pressed onto the surface of a glass substrate to be textured.

By contrast, aggregated polycrystalline diamond particles in the form of secondary particles are aggregates of many very small round particles without corners, having on the exterior many very small protrusions comprising primary particles. Since these protrusions get hooked to the surface of a polishing tape, these aggregated polycrystalline diamond particles can easily be held on the surface of a polishing tape during a texturing process and are dependably pressed onto the surface of a glass substrate.

Moreover, since these aggregated polycrystalline diamond particles in the form of secondary particles are aggregates of many very small polycrystalline diamond particles in the form of primary particles, the number of particles contacting a unit surface area of the glass substrate during the texturing process is greater than if primary particles with the same diameter as that of the secondary particles but having no small protrusions are used.

For the reasons given above, it can be understood that very fine and uniform streaks can be created on the surface of a glass substrate if use is made of a slurry material containing such aggregated polycrystalline diamond particles in the form of secondary particles.

Water or a water-based aqueous solution used in ordinary mechanical texturing processes is used for dispersing such aggregated polycrystalline diamond particles. Such solutions do not contain any substance such as potassium hydroxide and ammonium salts having hydroxyl groups and a characteristic of etching a glass material. Examples of such aqueous solution include water and water having a dispersant such as glycol compounds and anion surfactants added thereto.

Slurries containing aggregated polycrystalline diamond particles and an aqueous solution each in an amount of 0.01-1 weight %, and more particularly in an amount of 0.01-0.1 weight %, are preferred.

The invention is explained next by way of test and comparison examples.

As Test Example, slurry embodying this invention with composition shown in Table 1 was used to carry out a texturing process with a texturing machine as shown in FIG. 2 under conditions shown in Table 2 on surfaces of glass substrates for magnetic disks. A woven cloth tape with thickness 700 μm with nylon fibers of thickness 0.04 deniers was used.

TABLE 1

| | |
|---|---|
| Aggregated polycrystalline diamond particles | 0.05 weight % |
| (diameter = 0.1 μm) | |
| Pure water | 98.95 weight % |
| Organic phosphoric ester | 0.10 weight % |
| Higher aliphatic amide | 0.10 weight % |
| Glycol compounds | 0.65 weight % |
| Metal salts of higher aliphatic acid | 0.10 weight % |
| Anion surfactant | 0.05 weight % |

TABLE 2

| | | |
|---|---|---|
| Polishing time | 30 | seconds |
| Rotational velocity of substrate | 300 | rpm |
| Running speed of tape | 3 | inches/minute |
| Supply rate of slurry | 15 | cc/minute |
| Hardness of contact roller | 45 | duro |
| Oscillation | 5 | Hz (1 mm) |
| Tape pressure | 1.5 | kg |

For comparing with Test Example described above, an alkaline slurry material to which a material with an etching effect on glass (ammonia salt) has been added and of which the composition is shown in Table 3 was used to carry out a texturing process (Comparison Example 1) on surfaces of glass substrates by using a machine similar to the one used in Test Example (as shown in FIG. 2) under the same conditions as shown in Table 2.

TABLE 3

| | |
|---|---|
| Monocrystalline diamond particles (diameter of | 0.10 weight % |
| primary particles = 0.1 μm) | |
| Pure water | 98.29 weight % |
| Ammonium salt | 0.01 weight % |
| Non-ionic surfactant | 0.60 weight % |
| Organic phosphoric ester | 0.10 weight % |
| Higher aliphatic amide | 0.10 weight % |
| Glycol compounds | 0.65 weight % |
| Metal salts of higher aliphatic acid | 0.10 weight % |
| Anion surfactant | 0.05 weight % |

For comparing with Test Example described above, a slurry material, of which the composition is shown in Table 4, having monocrystalline diamond particles in the form of primary particles dispersed in an aqueous solution was used to carry out a texturing process (Comparison Example 2) on surfaces of glass substrates by using a machine similar to the one used in Test Example (as shown in FIG. 2) under the same conditions as shown in Table 2.

TABLE 4

| | |
|---|---|
| Monocrystalline diamond particles (diameter of | 0.10 weight % |
| primary particles 0.1 μm | |
| Pure water | 98.90 weight % |
| Organic phosphoric ester | 0.10 weight % |
| Higher aliphatic amide | 0.10 weight % |
| Glycol compounds | 0.65 weight % |
| Metal salts of higher aliphatic acid | 0.10 weight % |
| Anion surfactant | 0.05 weight % |

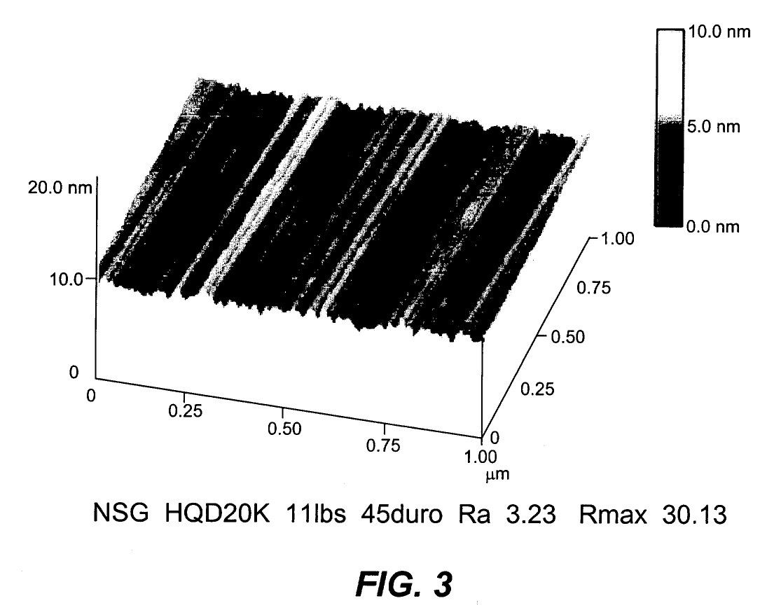

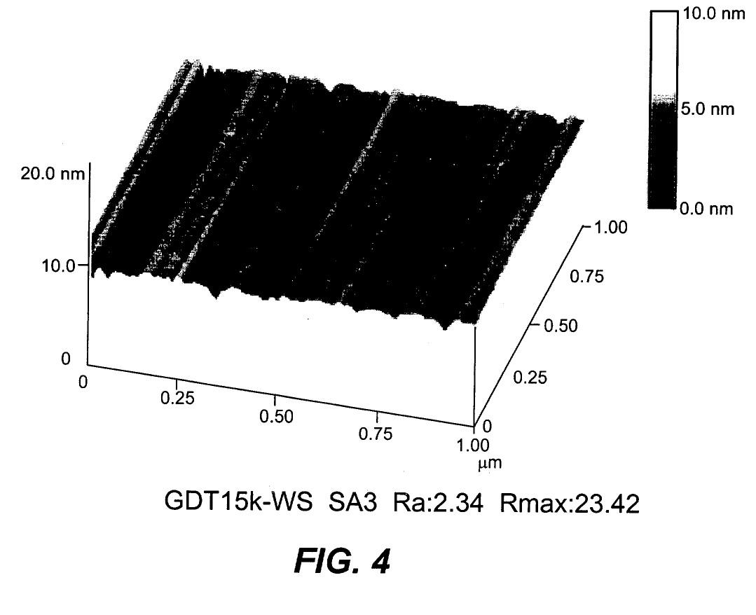

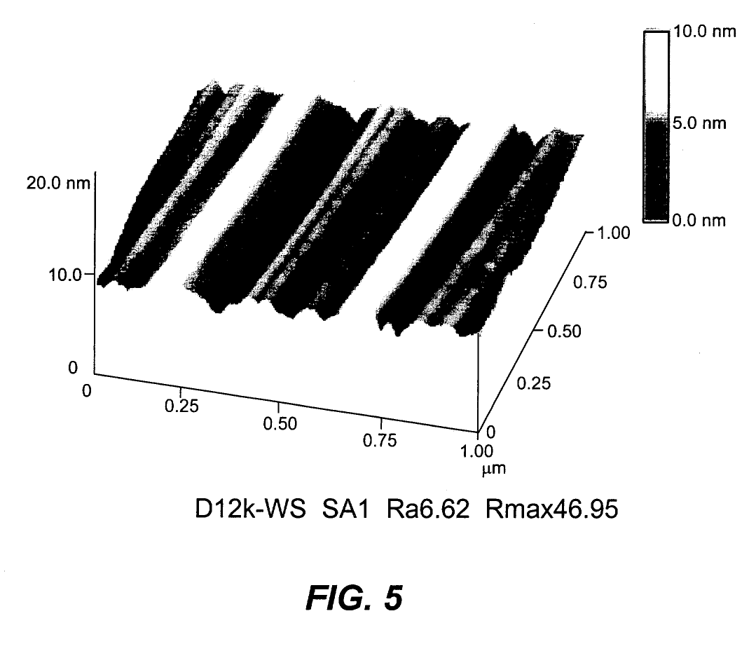

FIGS. 3, 4 and 5 are photographs of computer-drawn graphs showing the surface conditions of glass substrates textured by using slurry of Test Example, Comparison Example 1 and Comparison Example 2, respectively. The surface conditions of the glass substrates were inspected by means of a scan-type probe microscope (Nanoscope Dimension 3100 Series, produced by Digital Instruments Corporation) and the photographs of FIGS. 3, 4 and 5 were each taken of a graph showing in three-dimensional form the result of scanning an arbitrarily selected area of 30 μm×30 μm on the surface of the glass substrate.

These photographs show that the glass substrate surface of Test Example has been uniformly textured and the number of streaks per unit area is much greater than in the cases of Comparison Examples 1 and 2. In other words, the surface of a glass substrate can be textured more finely and uniformly by using a slurry material and by a method of this invention.

What is claimed is:

1. Slurry for use in texturing a surface of a glass substrate, said slurry comprising:
aggregates of polycrystalline diamond particles, said aggregates having diameters not larger than 0.5 μm; and
a liquid selected from the group consisting of water and water-based aqueous solutions, said aggregates being dispersed in said liquid.

2. The slurry of claim 1 wherein said polycrystalline diamond particles have diameters that are not larger than 20 nm.

3. The slurry of claim 1 wherein said liquid is free of substance that has an etching effect on a glass material.

4. The slurry of claim 2 wherein said liquid is free of substance that has an etching effect on a glass material.

5. A method of texturing a surface of a glass substrate, said method comprising the steps of:
rotating said substrate;
supplying slurry on said surface of said substrate, said slurry comprising aggregates of polycrystalline diamond particles and a liquid, said aggregates being in said liquid and having diameters not larger than 0.5 μm, said liquid being selected from the group consisting of water and water-based aqueous solutions; and
pressing a polishing tape against said surface while causing said polishing tape to run with respect to said surface.

6. The method of claim 5 wherein said polycrystalline diamond particles have diameters that are not larger than 20 nm.

7. The method of claim 5 wherein said polishing tape is one selected from the group consisting of woven cloth tapes, non-woven cloth tapes, foamed tapes and hair-implanted tapes.

8. The method of claim 5 wherein said liquid is free of substance that has an etching effect on a glass material.

9. The method of claim 6 wherein said liquid is free of substance that has an etching effect on a glass material.

10. The method of claim 7 wherein said liquid is free of substance that has an etching effect on a glass material.
